(19) United States
(12) Patent Application Publication
(10) Pub. No.: US 2025/0298405 A1
(43) Pub. Date: Sep. 25, 2025

(54) MODULAR AND DYNAMIC CONTROL OF MACHINES IN A NETWORK

(71) Applicant: Krones AG, Neutraubling (DE)

(72) Inventor: Sebastian FROEHLER, Teunz (DE)

(21) Appl. No.: 19/085,848

(22) Filed: Mar. 20, 2025

(30) Foreign Application Priority Data
Mar. 20, 2024 (DE) 10 2024 107 971.1

(51) Int. Cl. G05B 19/418; G06F 9/455

(52) U.S. Cl. CPC G05B 19/41865; G05B 19/41845; G05B 19/4185; G06F 9/45558; G06F 2009/45587; G06F 2009/45595

(57) ABSTRACT

The disclosure relates to a machine line and to a machine in the machine line, in particular in a machine line for filling and packaging food and/or beverages. The machine comprises an industrial PC that implements a software-defined edge apparatus for the machine and comprises a hypervisor. The hypervisor provides a virtual operating platform for hosting and/or operating corresponding services for the machine line operation. According to embodiments, the IPC or hypervisor implements a demilitarized zone with its own network segments in which the virtual operating platform is implemented. Furthermore, the IPC can establish a connection to a machine line network that connects a plurality of machines to one another, each of which comprises an IPC. The IPC is further configured to distribute workloads among the machine and at least one second machine in the machine line network.

### CROSS REFERENCE TO RELATED APPLICATION

The present application claims priority to German Patent Application No. 10 2024 107 971.1 filed on Mar. 20, 2024. The entire contents of the above-listed application are hereby incorporated by reference for all purposes.

### TECHNICAL FIELD

The disclosure relates to a machine, to a machine line and to a computer program, to a computer-readable storage medium for the modular and dynamic control of machines, in particular of machines in a machine line for filling and packaging food and/or beverages.

### BACKGROUND

In the field of industrial manufacturing, and in particular in the field of machine lines for food and beverage technology, the integration of network capabilities into these machine lines has led to significant advances. This development allows for improved monitoring, efficiency and automation of production, packaging and filling processes. However, the prior art has a number of significant disadvantages, for example, affecting both the operating costs and safety.

### SUMMARY

Currently, in practice, most machine systems are equipped with dedicated network switches at the line level. These switches are responsible for facilitating communication within individual production lines. While this solution ensures efficient data transfer within the lines, it leads to increased complexity in terms of network management. Each line requires its own switch, making network maintenance and scaling difficult. This becomes particularly problematic when adjustments or extensions to the system are necessary, since each change must be carried out individually on each line.

In addition to the switches, each line or system is connected to the central enterprise network by its own hardware router (i.e., across a line switch in each line), which requires a central location/network cabinet and is correspondingly costly and complex, and at the same time is not very modular and cannot be extended in a decentralized manner. This separate network infrastructure for each line not only increases management complexity but also increases hardware and maintenance costs. In particular in systems with multiple machines, this requires the provision of a central network cabinet, which involves considerable investment. The costs for such a device, including the necessary engineering services, can quickly exceed 10,000 euros, which represents a considerable financial burden, especially for smaller companies.

Another critical aspect is the so-called “bare-2-metal” installations, where software is installed directly on the hardware without an intermediate layer such as an operating system. Although this configuration offers performance benefits, it limits the flexibility and scalability of the systems.

Further disadvantages arise from the lack of security of these network configurations. Many systems do not meet basic security measures, such as firewalls. This neglect of network security and non-compliance with the ISA95 standard, an important industry standard for the integration of enterprise and control systems, makes the facilities susceptible to cyber attacks and data leaks. This can lead to serious consequences, including business interruptions, data loss, and even physical damage to equipment.

There is therefore a need for a solution that overcomes these disadvantages of the prior art and thus provides modular and dynamic control of machines in a machine network for filling and packaging machines, lines and systems.

This object is achieved according to the disclosure by a method, by a computer-readable storage medium and by a machine line as described herein.

One embodiment of the disclosure relates to a machine in a machine line, in particular in a machine line for filling and packaging food and/or beverages. The machine comprises an industrial PC (IPC) that implements a software-defined edge apparatus for the machine and comprises a hypervisor. The hypervisor provides a virtual operating platform for hosting and/or operating services for machine line operation. According to implementing regulations, the virtual operating platform or hypervisor “bare-to-metal” is installed on the IPC.

Further embodiments relate to a computer-readable storage medium and to a machine line.

### BRIEF DESCRIPTION OF THE FIGURES

Example aspects of the disclosure are shown in the drawings, in which:

FIG. 1 shows a diagram showing a honeycomb arrangement of cells in a network according to embodiments of the disclosure;

FIG. 2 shows an example machine showing an IPC and a plurality of virtualized network layers;

FIG. 3 shows an exemplary plant configuration for PET containers and adhesive containers;

FIG. 4 shows an exemplary plant configuration for PET containers and shrink packers;

FIG. 5 shows an exemplary plant configuration for cans or glass bottles; and

FIG. 6 shows an exemplary plant configuration for cans.

### DETAILED DESCRIPTION

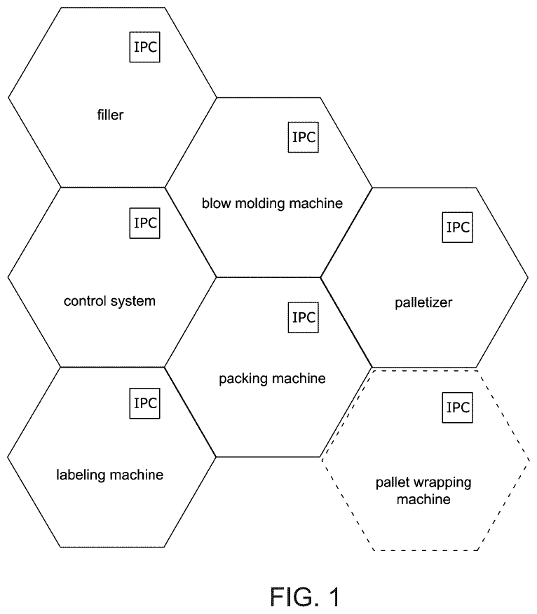

The disclosure provides an approach to overcome the disadvantages described above by implementing a “software-defined” edge apparatus for each machine in a machine line. According to embodiments, this can be implemented on an industrial PC (IPC). This allows the organization of the standalone edge apparatuses to be modular such that each machine acts like a cell that can be added in a modular fashion like in a honeycomb concept. This concept can be seen in FIG. 1, where an example arrangement of machines is organized in a honeycomb structure. Each of the example machines has a corresponding IPC that implements an operating platform or hypervisor. Such an operating platform can provide different services for the machine line operation. The hypervisor can be implemented on the IPC “bare-to-metal” and provide a virtualization environment that allows for simultaneous execution of a plurality of operating systems or virtual machines on a single physical IPC. This can allow different services to be carried out on the same IPC without these affecting one another or causing conflicts. In addition, services can be moved or duplicated between different IPCs by the hypervisor to ensure flexible scalability and reliability, as explained further below.

The more machines are organized in this way in a line, the more robust the given infrastructure is, since loads can be distributed by different embodiments. Examples of loads to be distributed are therefore services of different edge apparatus functionalities or line management, each of which is executed on this IPC.

The use of software-defined network technology, as disclosed in the embodiments described herein, allows for a large degree of flexibility and simplifies network management. In the example network architecture, this can be used to virtualize the network components. This leads to a reduction in physical network components and facilitates the modular and scalable configuration of the machine line.

According to embodiments, the IPC is configured to implement a software-defined edge apparatus for the machine and to comprise a hypervisor. The hypervisor provides a virtual operating platform for hosting and/or operating corresponding services for the machine line operation.

The hypervisor can further implement a demilitarized zone (DMZ) with its own network segments in which at least part of the virtual operating platform is implemented. For example, the DMZ hosts services that make a service publicly available on the Internet and/or exchange data with other cloud platforms. The DMZ is a zone or an example network segment. The DMZ is primarily for services that are publicly hosted on the Internet. There may be other network zones/segments, depending on how deeply the services should/need to be accordingly segmented.

According to embodiments, the machines, or the IPCs of the machines, can connect to one another and establish a connection to a network of the machine line. The machine line network thus connects a plurality of machines to one another, each of which also comprises an IPC as a software-defined edge apparatus configured according to embodiments. The modular composition of these “cells” (a cell means a machine with an IPC on which a hypervisor/operating platform is implemented) allows workloads to be distributed among the machines in the machine line network.

The cells according to embodiments each form a communicative independent unit in the machine line. Using an authorization, a cell can automatically connect to the machine line network, i.e., to the other cells. The IPC within the cell can serve as an entry/connection point for the cell and provide a firewall container for inbound and outbound communication.

When connecting a machine/cell to the network, the connection can be automatically detected and the correct assignment of the corresponding zone/VLAN can be made for the apparatuses as soon as they are connected to a switch, for example. For example, a central network management service can automatically connect connected (known/verified) devices to the correct network.

As can also be seen in FIG. 1, machines without the appropriate authorizations (“third-party machines”) can also be connected to the network. Visually marked in FIG. 1, the pallet wrapping machine is such a third-party machine in this example. If a machine/cell in the machine line is established as being a machine/cell that does not have authorization (trusted/position of trust), limited communication can still be established or maintained with the unauthorized machine. The limited communication may, for example, allow restricted access of the third-party machine to network resources and/or network segments in the network. Alternatively or additionally, the limited communication with the third-party machine can be monitored and logged.

For unknown devices (third-party machines), a user can be asked in an HMI dialog box whether the device is trustworthy, what type of device it is, what group it belongs to, etc. The network management service can then push the device into the correct zone and, if necessary, equip it with limited communication capability.

According to embodiments, if a machine in the machine line is determined to be infected with malware, communication with the infected machine may be terminated. This can be done especially efficiently, since each IPC or the software-defined firewall of each IPC performs appropriate data packet monitoring for inbound and/or outbound messages.

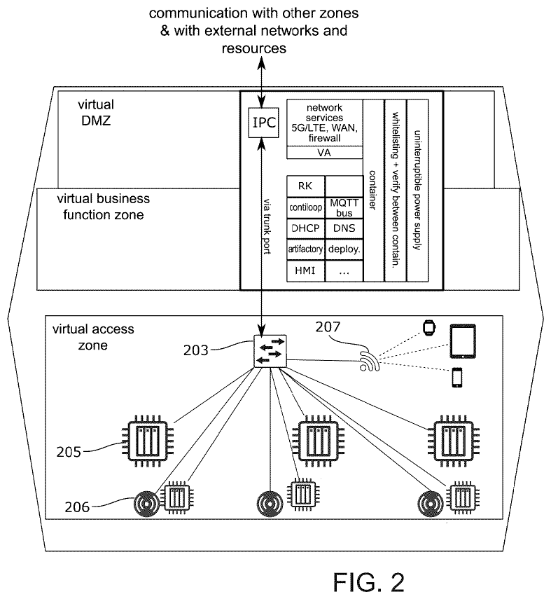

Distributing workloads among the machines/cells in the machine line network comprises distributing tasks required for the implementation of the network itself. For example, distributing tasks refers to software-defined network services from a list of services required for the network, such as an APN service, a DHCP service, a DNS service, an MQTT service, and so on. Further examples are shown in FIG. 2, which shows an example machine on which a virtual DMZ is implemented on the IPC. The IPC can provide the various services (for example in the DMZ and/or a virtual business function zone), or just some of them, so that the tasks are distributed among the cells in the network.

For example, some IPCs can handle connecting to a network (e.g., Internet, VPN, . . . ), other IPCs can handle a DHCP service, others a DNS service, while other IPCs can handle product workloads. This allows for a high level of flexibility and security and saves resources.

The distribution of tasks among the cells can comprise a number of other example tasks and aspects. For example, a cell can be used to handle dynamic packet distribution for the life cycle of at least one IPC. Furthermore, a cell can be responsible for controlling the communication of administration commands via a mobile data connection (such as over 5G) and controlling the download of packages and/or artifacts via a fiber/DSL connection. This allows the system to be started up even faster. In addition, the cell can also use the mobile 5G data connection for faster start-up and to download any required data if a fiber/DSL connection is not yet available.

For example, as shown in FIG. 2, the virtual access zone can be executed in a different kernel than the DMZ. The virtual access zone controls and receives data from IPCs 205 of the machine and from sensors 206 that record data at the machine. The virtual access zone can be used, for example, to communicate via a trunk port and a “managed switch” with Profinet compatibility. Direct access to HMIs or mobile devices can also be achieved via a data connection 207.

Embodiments of the disclosure thus provide a largely software-defined network technology concept so that no additional network hardware is required between the machines or lines. This allows the machines and their network to be constructed in a simple, modular and scalable manner.

The IPC, or the software-defined edge apparatus or the corresponding hypervisor of an IPC, may, according to embodiments, connect to, for example, a back-end service on which various additional services are available that can either be transferred to the IPC or can be executed on the back-end server. Furthermore, a connection can also be established to a data center where additional data, for example company-specific data, can be made available for the services.

The disclosure may be implemented on a computer configured to execute specific program instructions that allow for the functionality of the disclosure. The basic architecture of this computer comprises a plurality of core components, such as a central processing unit (CPU), memory, input-output systems, network connectivity, a bus, etc. The CPU is responsible for executing the program instructions. It processes data and controls other components of the system. The memory can comprise both a volatile memory (RAM) and a non-volatile memory (such as hard drives or SSDs). The RAM provides temporary storage for running processes and data, while the non-volatile memory allows for permanent data storage. The input/output systems allow the computer to interact with the outside world, including input devices such as a keyboard and mouse and output devices such as monitors and printers. Network connectivity allows the computer to connect to other computers and networks, allowing data exchange and remote access capability. The components can be connected to one another via a bus system.

The computer-readable storage medium contains program instructions that, when executed by the computer apparatus, configure the apparatus to implement the specific functions and processes of the disclosure. These instructions may be in the form of a software code written in a programming language and stored on the storage medium. When this code is executed by the CPU, it allows the computer to realize the disclosure by executing specific algorithms and processing steps.

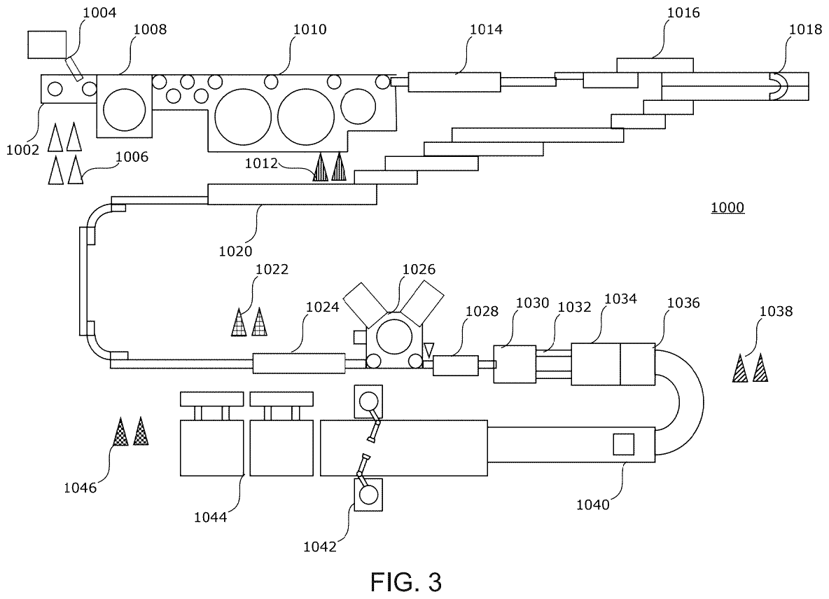

In the following FIGS. 3 to 6, various exemplary plant configurations for different bottle filling plants are described in which the disclosure or at least parts and aspects of the disclosure can be implemented. The description of FIGS. 3 to 6 is intended only to provide a general overview of machines for which state data can be collected and used as a basis for the LLM to be able to process user requests.

FIG. 3 shows an exemplary plant configuration 1000 for PET bottles or PET containers and adhesive containers. As can be seen in FIG. 3, the plant configuration 1000 comprises the most varied modules, which form a line at the end of which the ready-filled PET containers are dispensed in the form of a bundle on pallets. Some of the modules and machines can be optional, and the disclosure is not limited to the exact shape and arrangement of the plant configurations.

The plant configuration 1000 comprises a furnace 1002 for preforms, a preform sorting system with a feeding machine 1004, and a blow-molding machine 1008. Modules 1002, 1004, and 1008 form in general a stretch blow-molding machine in which PET containers are manufactured and formed from a raw material. The produced PET containers are forwarded to a filler 1010 in which the bottles are filled. The filler can optionally comprise a rinser. Various particles such as dust, cardboard, or remains of wooden pallets can collect in the preforms during storage or transport. These can be removed with the rinser. At the end of the filler, a closer can be arranged, using which the PET containers are closed after filling.

Optionally, the plant configuration 1000 can, after the filler 1010, comprise a rotating apparatus, which is used for hot filling of the PET containers. The filled PET containers are guided to a separator 1020 and further to a drying apparatus 1024 in which the PET containers are dried via one or more conveyor belts 1016, which can also comprise a buffer 1018 for intermediate loading of filled containers.

After drying, the PET containers are conveyed to a labeling machine 1026. The labeling machine 1026 can be configured for various labeling techniques such as labeling using hot glue, cold glue, self-adhesive labels, or sleeves. After printing or labeling the PET containers, the PET containers are passed through a second drying apparatus 1028, a line distributor 1030, conveyor belts 1032, adhesive container production 1034, and a curing section to a handle applicator. In adhesive packaging production 1034, the PET containers are grouped together in certain group sizes and packaged into a pack such as a “six-pack.” In the handle applicator, a carrying handle is attached to the pack, which allows the pack to be carried comfortably. The finished packs are then accordingly arranged by a robot 1042 for layer production and packed on pallets by a palletizer 1044.

In the plant configuration 1000, so-called format trolleys or format racks can be arranged on various modules and machines in order to provide quickly changeable format sets for short changeover times and automatic tool exchange. Examples of format trolleys are the format trolley 1006 for the blow-molding machine 1008, the format trolley 1012 for the filler 1010, the format trolley 1022 for the labeling machine 1026, the format trolley 1038 for the adhesive packaging production 1034, and the format trolley 1046 for the palletizer 1044.

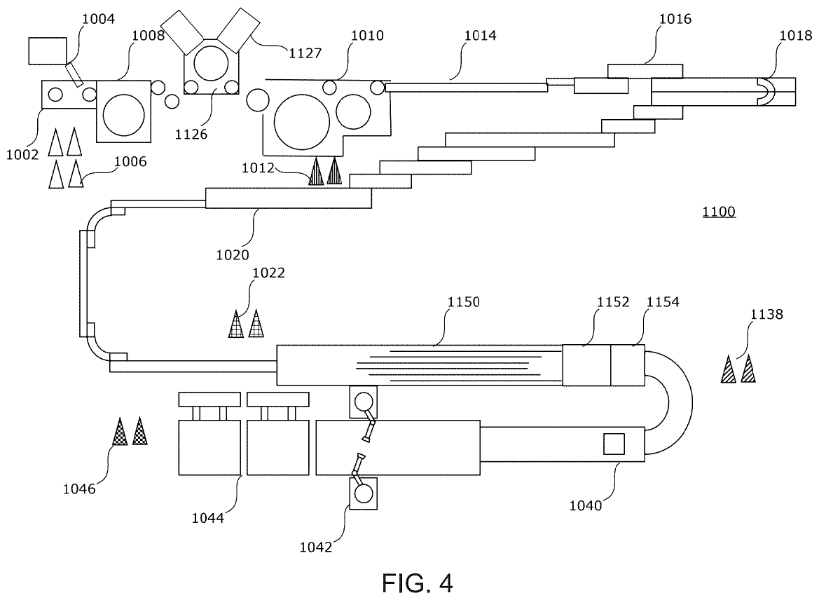

FIG. 4 shows another exemplary plant configuration 1100 for PET containers and shrink packers. The plant 1100 in FIG. 4 comprises many of the modules and machines from the plant configuration 1000 in FIG. 3, but there are some differences. The description of the modules that are already described in connection with FIG. 3 is therefore omitted for FIG. 4.

A key difference between the two exemplary plant configurations 1000 and 1100 is that the labeling machine 1126 with the labeling modules 1127 can already be installed after the blow-molding machine 1008 and before the filler 1008. For this purpose, the plant configuration 1100 can comprise six transport lanes 1150 into which the PET containers can be pushed. After the PET containers have been correspondingly pushed into one of the six lanes 1150, they are conveyed into the film wrapping module 1152 and then into the shrink tunnel 1154.

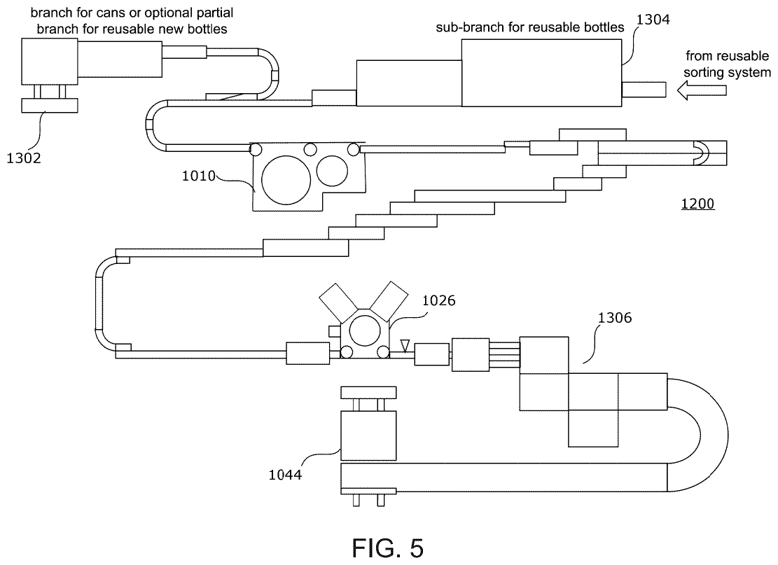

FIG. 5 shows an exemplary plant configuration 1200 for cans or glass bottles. The exemplary plant configuration 1200 from FIG. 5 again has some similarities to the plant configurations 1000 and 1100 from FIGS. 3 and 4, and the description of the plant configuration is therefore limited to the differences between the plant configurations.

As shown in FIG. 5, the exemplary plant configuration can comprise two separate feeds. A first feed, on the left in FIG. 5, shows a branch for cans or, optionally, a partial branch for reusable new bottles. The containers, i.e., cans or new bottles, are fed from a depalletizer 1302 into the machine, where they are guided via conveyor belts to the filler 1010. A second feed, on the right in FIG. 5, shows a partial branch for reusable bottles, which are introduced into the plant from a reusable sorting plant (not shown).

In the case where the reusable bottles that have already been used are introduced into the plant 1200 via the sub-branch for reusable bottles, the reusable bottles first pass through the cleaning machine or washing machine 1304. Another possible difference of the exemplary plant configuration 1200 is the transfer packer 1306 after the labeling machine 1026. The transfer packer can sort the bottles or cans into a carton clip application or into boxes, or both.

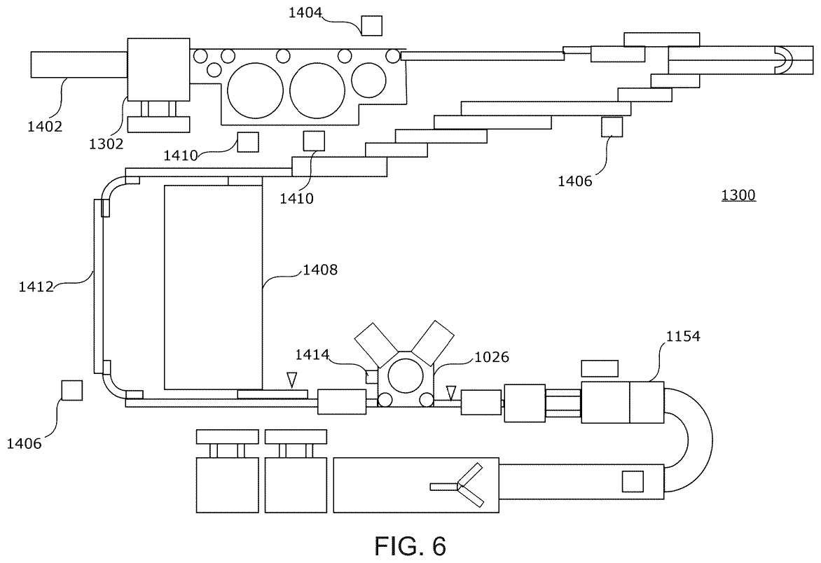

FIG. 6 shows an exemplary plant configuration 1300 for cans, in which the elements already described in the other plant configurations are not described. The cans in the plant configuration 1300 are introduced from a magazine 1402 with cans into the depalletizer 1302. The cans, after they have passed through the filler and are filled, are closed by a closure magazine 1404 and are then transported further along the plant 1400 via the conveyor belts as described above.

The optional pasteurizer 1408 can be circumvented via the bypass 1412 if it is not required. In the pasteurizer 1408, the freshly filled products can be pasteurized for preservation.

In contrast to the plant configurations 1000, 1100, and 1200, the exemplary plant configuration 1300 shows various tanks for corresponding consumables, such as the tanks 1410 with rinsing liquid and/or the filling product, and the tanks 1406 with belt lubricant. These tanks can also be contained in the above-described exemplary plant configurations. For example, the chemical products 106 that are fed from the mixer 110 to the machines can be stored in the tanks 1406 and 1410.

1. A machine in a machine line, wherein the machine comprises:
an industrial PC that implements a software-defined edge apparatus for the machine and comprises a hypervisor, wherein the hypervisor is configured to:
provide a virtual operating platform for hosting and/or operating corresponding services for the machine line operation.

2. The machine according to claim 1, wherein the hypervisor is further configured to:
implement a demilitarized zone, having its own network segments in which at least part of the virtual operating platform is implemented, wherein services are hosted in the DMZ that make a service publicly available on the Internet and/or exchange data with other cloud platforms.

3. The machine according to claim 1, wherein the hypervisor is further configured to:
establish a connection to a machine line network, wherein the machine line network connects a plurality of machines to one another, wherein each of the plurality of machines implements an IPC as a software-defined edge apparatus for the corresponding machine and comprises a corresponding hypervisor; and
distribute workloads among the machine and at least one second machine in the machine line network;
wherein, if an IPC of a machine from the network fails, the hypervisor is configured to redistribute and/or take over the workload of the failed IPC.

4. The machine according to claim 1, wherein:
the machine forms a communicatively independent cell in the machine line;
the machine automatically connects to the machine line network using an authorization; and
the IPC within the cell is an entry/connection point for the cell and provides a firewall container for inbound and outbound communication.

5. The machine according to claim 1, wherein the IPC is further equipped with WAN, 5G and/or LTE communication means and can independently connect to the Internet via the WAN, 5G and/or LTE communication means.

6. The machine according to claim 3, wherein the hypervisor is further configured to:
determine that a machine in the machine line is an unauthorized machine; and
establish limited communication with the unauthorized machine, wherein the limited communication allows restricted access of the unauthorized machine to network resources and/or network segments in the network and/or wherein the limited communication with the unauthorized machine is monitored and logged; and/or
determine that an IPC of a machine in the machine line is infected with malware and terminate communication with the infected machine.

7. The machine according to claim 3, wherein distributing workloads among the machine and at least one second machine in the machine line network comprises:
distributing tasks relating to a software-defined network service from a list of services required for the network; and/or
dynamic packet distribution for a life cycle of at least one IPC; and/or
controlling or communicating administration commands via a mobile data connection and downloading packages and/or artifacts via a fiber/DSL connection; and/or
additionally using a mobile 5G data connection for faster start-up if a fiber/DSL connection is not yet available.

8. The machine according to claim 1, wherein the hypervisor is further configured to:
virtualize a firewall and/or router functionality as software-defined functions so that the access layer and core layer are integrated in one hardware unit of the IPC.

9. A computer-readable storage medium having program instructions recorded thereon that, when executed by at least one computer apparatus, configure the at least one computer apparatus to:
implement a hypervisor for a software-defined edge apparatus for a machine, wherein the hypervisor is configured to:
provide a virtual operating platform for hosting and/or operating corresponding services for the machine line operation
wherein the machine is part of a machine line.

10. A machine line, wherein the machine line comprises:
a plurality of machines connected to one another via a network, wherein each of the machines comprises an industrial PC that implements a software-defined edge apparatus for the machine and comprises a hypervisor, wherein the hypervisor is configured to:
provide a virtual operating platform for hosting and/or operating corresponding services for the machine line operation.

11. The machine according to claim 1, wherein the machine line is for filling and packaging food and/or beverages.

12. The machine according to claim 7, wherein the software-defined network service list of services includes an APN service, a DHCP service, a DNS service, and/or an MQTT service.

13. The machine according to claim 3, wherein distributing workloads among the machine and at least one second machine in the machine line network comprises:
distributing tasks relating to a software-defined network service from a list of services required for the network.

14. The machine according to claim 3, wherein distributing workloads among the machine and at least one second machine in the machine line network comprises:
dynamic packet distribution for a life cycle of at least one IPC.

15. The machine according to claim 3, wherein distributing workloads among the machine and at least one second machine in the machine line network comprises:
controlling or communicating administration commands via a mobile data connection and downloading packages and/or artifacts via a fiber/DSL connection.

16. The machine according to claim 3, wherein distributing workloads among the machine and at least one second machine in the machine line network comprises:
additionally using a mobile 5G data connection for faster start-up if a fiber/DSL connection is not yet available.
